(19) United States
(12) Patent Application Publication
(10) Pub. No.: US 2016/0110011 A1
(43) Pub. Date: Apr. 21, 2016

(54) DISPLAY APPARATUS, CONTROLLING METHOD THEREOF AND DISPLAY SYSTEM

(71) Applicant: Samsung Electronics Co., Ltd., Suwon-si (KR)

(72) Inventors: Chun-woo PARK, Suwon-si (KR); Young-ran HAN, Suwon-si (KR); Jeong-hyun PARK, Suwon-si (KR)

(73) Assignee: Samsung Electronics Co., Ltd., Suwon-si (KR)

(21) Appl. No.: 14/884,891

(22) Filed: Oct. 16, 2015

(30) Foreign Application Priority Data
Oct. 17, 2014 (KR) 10-2014-0141073

(51) Int. Cl. G06F 3/041

(52) U.S. Cl. CPC G06F 3/0416; G06F 3/0412

(57) ABSTRACT

A display apparatus, a controlling method thereof, and a display system are provided. According to the display apparatus, in response to detecting a plurality of input apparatuses having different touch patterns through a display allowing a touch and including a touch panel, the plurality of input apparatuses are identified using the detected touch patterns, and the display apparatus is controlled independently according to each of a plurality of touch interactions which are input through the plurality of input apparatuses.

### CROSS-REFERENCE TO RELATED APPLICATIONS

This application claims priority from Korean Patent Application No. 10-2014-0141073, filed in the Korean Intellectual Property Office on Oct. 17, 2014, the disclosure of which is incorporated herein by reference.

### BACKGROUND

1. Field

Aspects of the exemplary embodiments relate to a display apparatus, a controlling method thereof, and a display system and more particularly, to a display apparatus which is controlled by an input apparatus including a separate identification mark, a controlling method thereof, and a display system.

2. Description of the Related Art

Recently, various functions are provided through a display apparatus (for example, TV, smart phone, tablet PC, notebook PC, etc.). For example, a display apparatus not only displays image contents but also performs various functions such as the functions of performing Internet search, generating and editing contents, managing schedule, managing health, etc.

In addition, various methods are used to control the functions of a display apparatus, including the method of receiving a touch command using a user's body part, the method of receiving a command using a touch pen or other separate input apparatuses, etc.

However, if a plurality of users use a display apparatus, or a plurality of functions of a display apparatus are used by a single user, it is difficult to distinguish the users or the functions.

Accordingly, a method for identifying different apparatuses where a touch interaction is input according to a user or a function is required.

### SUMMARY

Additional aspects and/or advantages will be set forth in part in the description which follows and, in part, will be apparent from the description, or may be learned by practice of the embodiments.

An aspect of the exemplary embodiments relates to a display apparatus capable of identifying different input apparatuses where a touch interaction is input, a controlling method thereof, and a display system.

According to an exemplary embodiment, there is provided a display apparatus including a display configured to include a touch panel and a controller configured to, in response to detecting a plurality of input apparatuses having different touch patterns through the touch panel, identify the plurality of input apparatuses using the detected touch patterns, and control the display apparatus independently according to each of a plurality of touch interactions which are input through the plurality of input apparatuses.

The controller, in response to detecting an input apparatus having a first pattern through the touch panel, may determine the input apparatus as a first input apparatus, and in response to detecting an input apparatus having a second pattern, determine the input apparatus as a second input apparatus.

The controller may control the display apparatus to perform a first function according to a touch interaction which is input through the first input apparatus, and control the display apparatus to perform a second function according to a touch interaction which is input through the second input apparatus.

The controller, in response to the first pattern being changed to the second pattern while recognizing the first pattern from an input apparatus having the first pattern from among the plurality of input apparatuses, may determine that a user command to control a display item on a touch panel where the input apparatus is located is input.

The controller, in response to the first pattern being changed to the second pattern while recognizing the first pattern from an input apparatus having the first pattern from among the plurality of input apparatuses, may determine that a user controlling the input apparatus is changed.

The controller, in response to detecting an input apparatus having the touch pattern through the touch panel at a same location for more than a predetermined time or a setting manipulation to recognize a change of a user controlling the input apparatus being input, may control the display to display a UI to register a user who uses the input apparatus.

The apparatus may further include a storage, and the controller may control the storage to match and store a registered user according to the touch pattern.

According to an exemplary embodiment, there is provided a controlling method of a display apparatus including detecting a plurality of input apparatuses having different touch patterns through the touch panel, identifying the plurality of input apparatuses using the detected touch patterns, and controlling the display apparatus independently according to each of a plurality of touch interactions which are input through the plurality of input apparatuses.

The identifying may include, in response to detecting an input apparatus having a first pattern through the touch panel, determining the input apparatus as a first input apparatus, and in response to detecting an input apparatus having a second pattern, determining the input apparatus as a second input apparatus.

The controlling may include controlling the display apparatus to perform a first function according to a touch interaction which is input through the first input apparatus, and controlling the display apparatus to perform a second function according to a touch interaction which is input through the second input apparatus.

The method may further include, in response to the first pattern being changed to the second pattern while recognizing the first pattern from an input apparatus having the first pattern from among the plurality of input apparatuses, determining that a user command to control a display item on a touch panel where the input apparatus is located is input.

The method may further include, in response to the first pattern being changed to the second pattern while recognizing the first pattern from an input apparatus having the first pattern from among the plurality of input apparatuses, determining that a user controlling the input apparatus is changed.

The method may further include, in response to detecting an input apparatus having the touch pattern through the touch panel at a same location for more than a predetermined time or a setting manipulation to recognize a change of a user controlling the input apparatus being input, displaying a UI to register a user who uses the input apparatus.

The method may further include matching and storing a registered user according to the touch pattern.

According to an exemplary embodiment, there is provided a display system including an input apparatus including a touch pattern and a display apparatus configured to, in response to detecting an input apparatus having the touch pattern through a touch panel, identify the input apparatus using the detected touch pattern, and receives a touch interaction through the input apparatus.

The display apparatus, in response to detecting an input apparatus having a first pattern through the touch panel, may determine the input apparatus as a first input apparatus, and in response to detecting an input apparatus having a second pattern, determine the input apparatus as a second input apparatus.

The input apparatus may include a plurality of touch patterns, and in response to a user command to control a display item displayed on the display apparatus indicated by the input apparatus being input, change an activated touch pattern.

According to the various exemplary embodiments, a user may use a display apparatus capable of identifying different input apparatuses where a touch interaction is input, a controlling method thereof, and a display system.

### BRIEF DESCRIPTION OF THE DRAWINGS

The above and/or other aspects of the present embodiments will be more apparent by describing certain exemplary embodiments of the present embodiments with reference to the accompanying drawings, in which:

FIG. 1 is a view illustrating a display system according to an exemplary embodiment;

FIG. 2 is a block diagram illustrating configuration of a display apparatus according to an exemplary embodiment;

FIG. 3 is a view illustrating an input apparatus including a touch pattern according to an exemplary embodiment;

FIGS. 4A to 4C are views illustrating an input apparatus including a touch pattern and a user input unit;

FIGS. 5A and 5B are views illustrating an input apparatus including a plurality of touch patterns;

FIGS. 6A to 6C are views illustrating a display apparatus which displays a UI;

FIG. 7 is a flowchart illustrating a controlling method of a display apparatus according to an exemplary embodiment;

FIG. 8 is a view illustrating an exemplary embodiment of executing a game application in a display apparatus using a plurality of input apparatuses;

FIGS. 9A to 9C are views illustrating an exemplary embodiment of storing a record of usage of a display apparatus by each user; and

FIGS. 10A and 10B are views illustrating an input apparatus including a plurality of touch patterns according to an exemplary embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present embodiments by referring to the figures.

The exemplary embodiments may vary, and may be provided in different exemplary embodiments. Specific exemplary embodiments will be described with reference to accompanying drawings and detailed explanation. However, this does not necessarily limit the scope of the exemplary embodiments to a specific embodiment form. Instead, modifications, equivalents and replacements included in the disclosed concept and technical scope of this specification may be employed. While describing exemplary embodiments, if it is determined that the specific description regarding a known technology obscures the gist of the embodiments, the specific description is omitted.

In the present disclosure, relational terms such as first and second, and the like, may be used to distinguish one entity from another entity, without necessarily implying any actual relationship or order between such entities.

The terms used in the following description are provided to explain a specific exemplary embodiment and are not intended to limit the scope of rights. A singular term includes a plural form unless it is intentionally written that way. The terms, “include”, “comprise”, “is configured to”, etc. of the description are used to indicate that there are features, numbers, steps, operations, elements, parts or combination thereof, and they should not exclude the possibilities of combination or addition of one or more features, numbers, steps, operations, elements, parts or combination thereof.

In an exemplary embodiment, ‘a module’ or ‘a unit’ performs at least one function or operation, and may be realized as hardware, software, or combination thereof. In addition, a plurality of ‘modules’ or a plurality of ‘units’ may be integrated into at least one module and may be realized as at least one processor (not shown) except for ‘modules’ or ‘units’ that should be realized in a specific hardware.

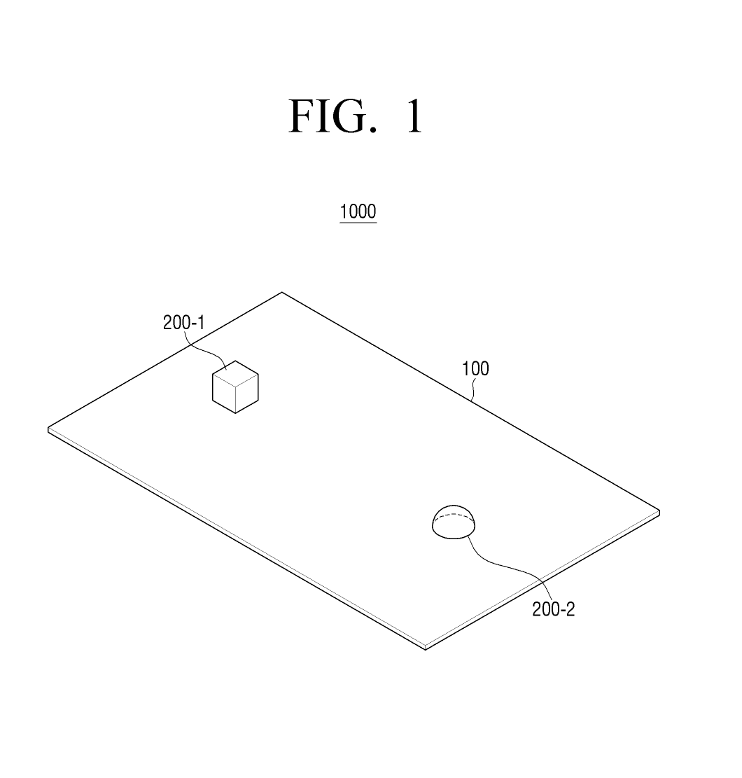

FIG. 1 is a view illustrating a display system 1000 according to an exemplary embodiment. As illustrated in FIG. 1, the display system 1000 may include a display apparatus 100 and a plurality of input apparatuses 200-1, 200-2. FIG. 1 illustrates the display system 1000 including two input apparatuses, but this is only an example. The display apparatus 1000 may include at least one input apparatus.

The display apparatus 100 may be realized as an electronic blackboard including a touch panel, but this is only an example. The display apparatus 100 may be realized as various electronic apparatuses including a display which has a touch panel, such as TV, mobile phone. Smart phone, PDP, PDA, tablet PC, home theater, digital camera, notebook PC, etc.

The plurality of input apparatuses 200-1, 200-2 may include at least one touch pattern, respectively. In particular, the plurality of input apparatuses 200-1, 200-2 may include a touch pattern of which form is different from each other. Thus, the display apparatus 100 may identify an input apparatus according to the form of a detected touch pattern.

In addition, each of the plurality of input apparatuses 200-1, 200-2 may include a plurality of touch patterns. For example, as illustrated in FIG. 1, the first input apparatus 200-1 which is configured in the form of a polyhedron may include a different touch pattern on each side. The second input apparatus 200-2 which is configured in the form of a semi sphere may include a plurality of touch patterns on a side which is in contact with the display apparatus 100. The specific method of embodying a touch pattern of an input apparatus will be described later.

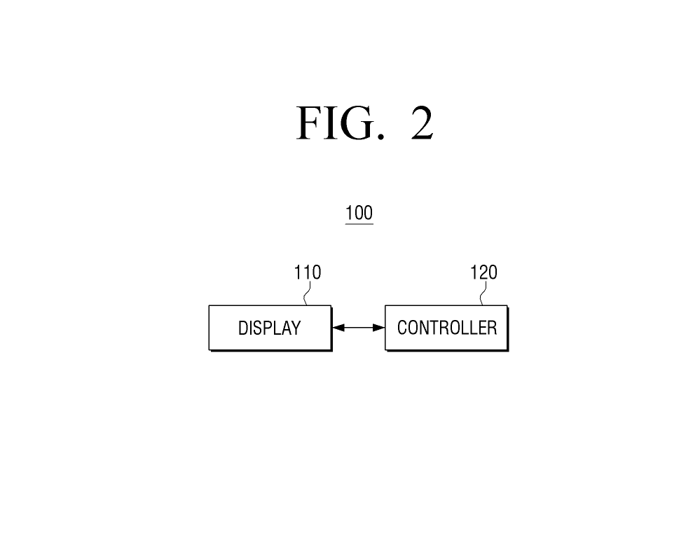

FIG. 2 is a block diagram illustrating configuration of the display apparatus 100 according to an exemplary embodiment. As illustrated in FIG. 2, the display apparatus 100 may include a display 110 and a controller 120 (such as a computer).

The display 110 displays an image. In particular, the display 110 may be configured to include a touch panel. Accordingly, the display 110 may receive a user command to control a display item. In particular, if a touch panel is realized in a capacitive form, the display 110 may receive a user command using an input means such as a user's finger or a touch pen for a capacitive touch panel.

Specifically, the display 110 according to an exemplary embodiment may receive a user's touch interaction through a separate input apparatus which is realized as a conductor or an input apparatus including a touch pattern which is realized as a conductor.

In addition, the display 110 may display various UIs (User Interfaces). In particular, the display 110 may display a UI for registering users who use each of a plurality of input apparatuses. In other words, if a touch interaction is input through a plurality of input apparatuses having different touch patterns, the display 110 may display a UI for setting and registering a user's nickname, ID, etc. with respect to each input apparatus.

Meanwhile, realizing the display 110 as a touch panel is only an example, and the display apparatus 100 may include a camera to photograph a touch pattern printed in an input apparatus and determine the form of the touch pattern or may include various sensors to detect a touch pattern of an input apparatus.

The controller 120 controls the overall operations of the display apparatus 100. In particular, if a plurality of input apparatuses having different touch patterns are detected through a touch panel, the controller 120 may identify the plurality of input apparatuses using the detected touch patterns. In addition, the controller 120 may control the display 100 independently according to each touch interaction input through the plurality of input apparatuses.

If an input apparatus having a first pattern is detected through a touch panel, the controller 120 may determine the input apparatus as a first input apparatus, and if an input apparatus having a second pattern is detected, the controller 120 may determine the input apparatus as a second input apparatus. In addition, the controller 120 may control a display apparatus to perform a first function according to a touch interaction input through the first input apparatus, and control the display apparatus to perform a second function according to a touch interaction input through the second input apparatus.

Accordingly, if an input apparatus having a different touch pattern is detected through the touch panel, the controller 120 may determine that a user controlling each input apparatus is different, or may determine that the input apparatus is to control a different function.

Specifically, if it is detected that the first pattern is changed to the second pattern while the first pattern is recognized from an input apparatus having the first pattern from among the plurality of input apparatuses, the controller 120 may determine that a user command to select a display item is input on the touch panel where the input apparatus is located.

Alternatively, if it is detected that the first pattern is changed to the second pattern while the first pattern is recognized from an input apparatus having the first pattern from among the plurality of input apparatuses, the controller 120 may determine that a user controlling the input apparatus is changed.

Meanwhile, if an input apparatus having a touch pattern is detected through a touch panel at the same location for more than a predetermined time, the controller 120 may control the display 110 to display a UI for registering a user who uses the input apparatus.

The display 100 may further include a storage (not shown). Accordingly, the controller 120 may control the storage to match and store a user according to a detected touch pattern.

According to the above-described display apparatus 100, when a plurality of users use the display apparatus 100 simultaneously using input apparatuses including different touch patterns, the users may control the display apparatus 100 individually.

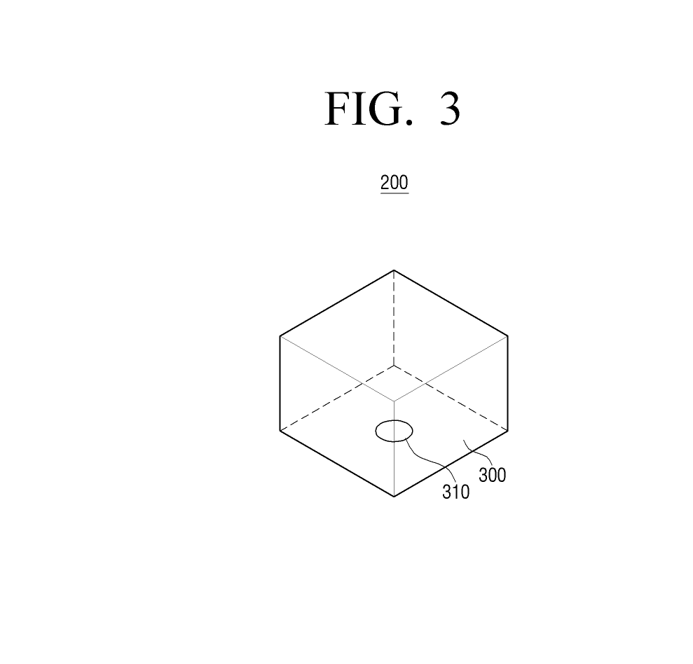

FIG. 3 is a view illustrating an input apparatus 200 including a touch pattern according to an exemplary embodiment. FIG. 3 illustrates an exemplary embodiment where the input apparatus 200 is configured in the form of a hexahedron, but this is only an example. The input apparatus 200 may be realized in various forms. In particular, the input apparatus 200 may have the form and size which are suitable for a user to grab the input apparatus, and if the display apparatus 100 targets a user in a specific age, the input apparatus 200 may be designed such that it is suitable for the user to use the input apparatus. For example, if the display apparatus 100 is for child's education, the input apparatus 200 may be designed in the form of a car.

As illustrated in FIG. 3, the input apparatus 200 in the form of hexahedron may include a touch pattern 310 on one side 300. In particular, if the display 110 included in the display apparatus 100 includes a capacitive touch panel, the input apparatus 200 may include the touch pattern which is realized as a conductor. Accordingly, if the one side 300 of the input apparatus 200 is touched on the display 110 by a user, the display apparatus 100 may detect the touch pattern 310 in a specific form (in this case a disk or circular pattern).

Specifically, if a touch interaction of touching a capacitive touch panel of the display apparatus 100 is performed by the input apparatus 200, the capacitance C of the touch pattern 310 which is realized as a conductor of the input apparatus 200 is changed. Accordingly, the display apparatus 100 detects the change of the capacitance C and thus, detect the touch interaction of the input apparatus 200.

In particular, the display apparatus 100 may detect a specific form of the touch pattern 310 included in the input apparatus 200. Accordingly, if the form of the detected touch pattern is different, the display apparatus 100 may determine that it is a different input apparatus. With respect to each of the identified input apparatuses, a different ID may be assigned. In other words, the display apparatus 100 may determine that a user command input through each input apparatus is a user command input by a user having a different ID.

Meanwhile, if the one (entire) side 300 of the input apparatus 200 is realized as a conductor, the display apparatus 100 may detect the form of the one side 300 of the input apparatus 200. For example, the display apparatus 100 may recognize that an input apparatus having a square side is a different from an input apparatus having a triangle side.

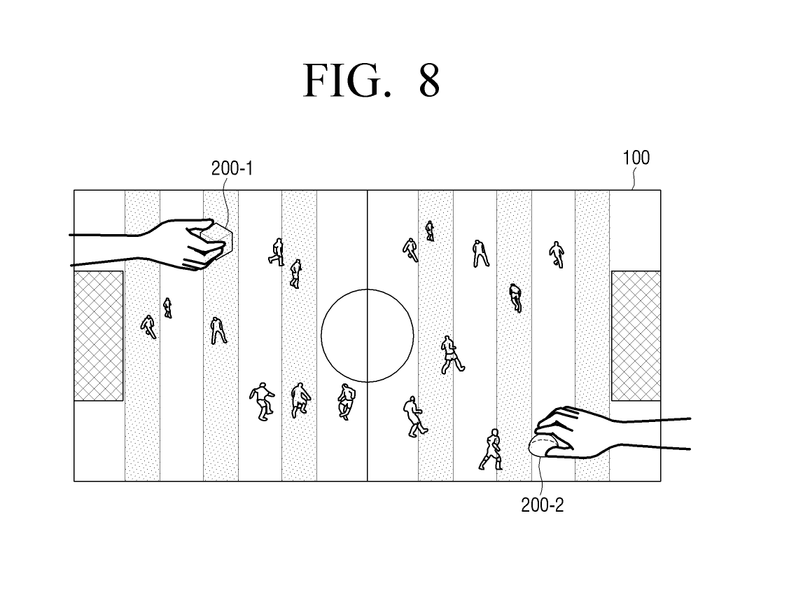

The method for the display apparatus 100 to recognize a plurality of input apparatuses according to the above-described method can be used when the display apparatus 100 executes a game application as illustrated in FIG. 8.

Specifically, as illustrated in FIG. 8, when two users use a game application using two different input apparatuses 200-1, 200-2, the display apparatus 100 may detect touch patterns which are embodied as different conductors included in the different input apparatuses 200-1, 200-2, and receive a user command to control a game item distinctively by each user.

In the exemplary embodiment of FIG. 8, the form of the side of each input apparatus 200-1, 200-2 where a touch is input on the touch panel is different as one is a square and the other is a circle. Accordingly, even when the side of each input apparatus 200-1, 200-2 where a touch is input on the touch panel is realized as a conductor, the display apparatus 100 may detect the form of the side of the input apparatuses 200-1, 200-2, and receive a user command which is different for each user.

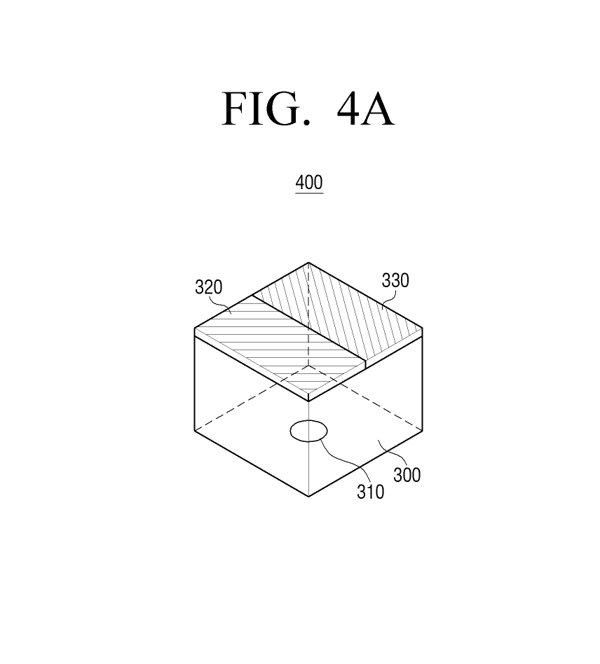

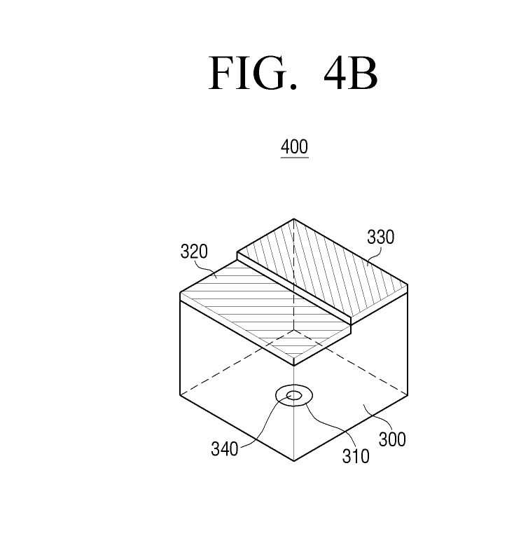

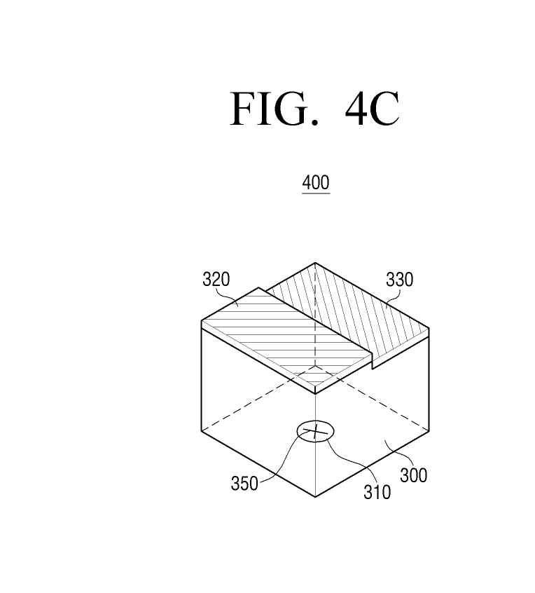

FIGS. 4A to 4C are views illustrating an input apparatus 400 including an input unit according to an exemplary embodiment. As illustrated in FIG. 4A, a user may input a touch interaction with respect to the display apparatus 100 using the input apparatus 400, and may input a user command to select, move or set a display item displayed on a touch panel using input units 320, 330 included in the input apparatus 400.

As illustrated in FIG. 4B, if the first input unit (or button) 320 included in the input apparatus 400 is selected, the input apparatus 400 may change the form of a touch pattern. When the change in the touch pattern of the input apparatus 400 is detected, the display apparatus 100 may determine that a user command to control an item displayed on the touch panel is input.

Specifically, if the first input unit 320 included in the input apparatus 400 is selected, the input apparatus 400 may activate an additive touch pattern 340 in the touch pattern 310 which is provided to identify apparatuses.

There may be various ways to activate the additive touch pattern 340. For example, if the additive touch pattern 3340 is located further inside than the touch pattern 310 of the input apparatus 400, when a user command to select the first input unit 320 is input, the location of the additive touch pattern 340 may be adjusted physically such that the additive touch pattern 340 is located on the same plane as the touch pattern 310.

In other words, the additive touch pattern 340 may be moved in a direction corresponding to a user command to press the first input unit 320. Accordingly, the additive touch pattern 340 and the touch pattern 310 may be located on the same plane.

In addition, the input apparatus 400 may control such that an electric current does not flow until a user command with respect to the additive touch pattern 340 which is related as a conductor is input. Accordingly, when a user command to select the first input unit 320 is input, the input apparatus 400 may activate the additive touch pattern 340 electrically so as to change the form of the touch pattern.

As illustrated in FIG. 4C, if the second input unit (or button) 330 included in the input apparatus 400 is selected, the input apparatus 400 may change the touch pattern so that it has a different form from when the first input unit 320 is selected.

Accordingly, the display apparatus 100 may detect the change in the form of the touch pattern which has been input, and control a display item displayed on the touch panel according to a user command.

For example, as illustrated in FIG. 4B, if a user command to select the first input unit 320 is input, the display apparatus 100 may control such that a display item displayed on the touch panel is selected. In addition, as illustrated in FIG. 4C, if a user command to select the input unit 330 is selected, the display apparatus may control to display a setting menu of a display item displayed on the touch panel.

Specifically, when a game application is executed in the display apparatus 100, if a user performs a tap interaction on an item that the user wishes to select without pressing the first input unit 320 and the second input unit 330, the corresponding item can be selected. In addition, a specific function of the selected item may be performed by the user's manipulation of pressing the first input unit 320. For example, the function set in the selected item may be performed. In addition, another function of the item which is selected by the user's manipulation of pressing the second input unit 330 may be performed. For example, the function of changing the form of the selected item may be performed.

In other words, a user may not only select or move a displayed item but also control a display item in various ways by using an input apparatus including at least one input unit.

Meanwhile, if a touch interaction is detected along with a user command to press the first input unit 320, the display apparatus 100 may detect the touch interaction as a touch interaction of a first user, an if a touch interaction is detected along with a user command to press the second input unit 330, may detect the touch interaction as a touch interaction of a second user.

In FIGS. 4A to 4C, an exemplary embodiment of changing a touch pattern according to a user command to press the input units 320, 330 is illustrated, but the input units may be embodied in various ways such as a toggle.

As described above, a user may control contents displayed in the display apparatus 100 in various ways by changing a touch pattern in a predetermined form, which is included in an input apparatus.

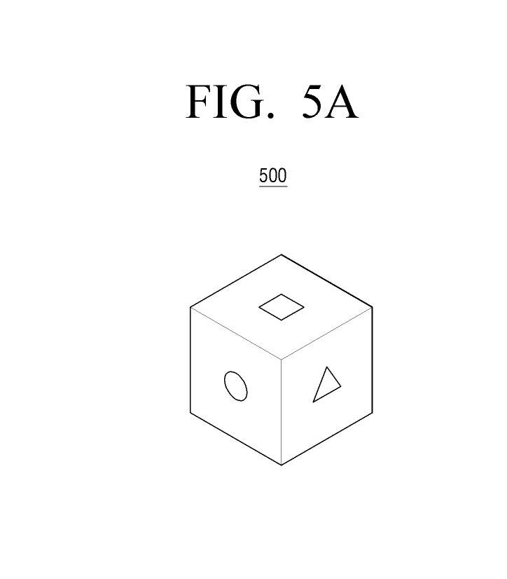

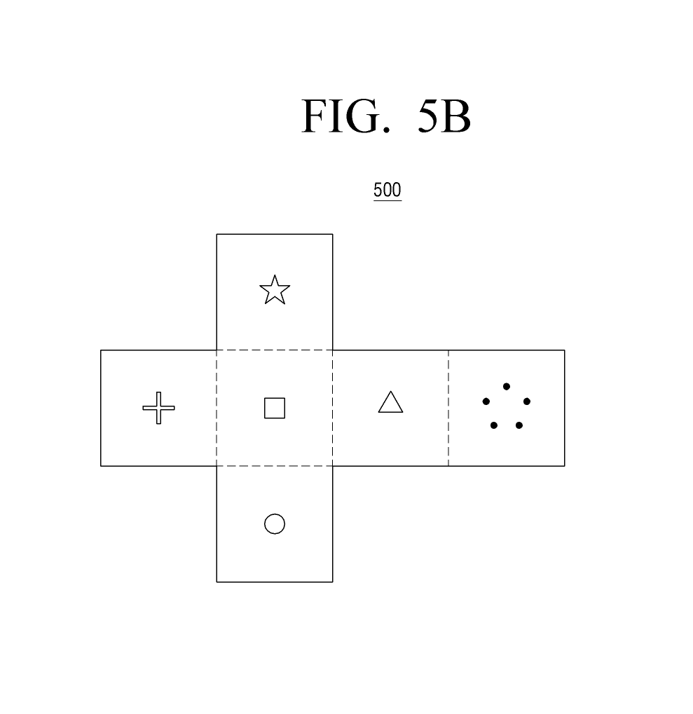

Meanwhile, an input apparatus may include a plurality of touch patterns on a plurality of sides. Hereinafter, an input apparatus 500 including a plurality of touch patterns will be described with reference to FIGS. 5A and 5B.

The input apparatus 500 in the form of hexahedron may include a different touch pattern on each side as illustrated in FIG. 5A. In other words, even though the display system 1000 does not include a plurality of input apparatuses, the display system 1000 may include one input apparatus 500 including a plurality of touch patterns as illustrated in FIG. 5A.

FIG. 5B is a development or laid open view of the input apparatus 500 illustrated in FIG. 5A. As illustrated in FIG. 5B, the input apparatus 500 may include a touch pattern in a different form or shape on each side.

Accordingly, as a user changes the side of the input apparatus 500 which comes in contact with a touch panel of the display apparatus 100, the user may control to execute different functions. For example, if a touch interaction to cause the side including a square-shaped touch pattern of the input apparatus 500 to touch the touch panel is input, a cursor displayed on the display apparatus 100 may move to a location corresponding to the input apparatus 500.

The side of the input apparatus 500 which comes in contact with the touch panel may be changed by a user while a touch interaction is input. For example, if a tap interaction is input with respect to the touch panel by the side including a triangle-shaped touch pattern of the input apparatus 500, the display apparatus 100 may change a displayed page to a next page and display the next page.

In addition, if the side where a touch interaction is input is changed to the side including a cross-shaped touch pattern, the display apparatus 100 may display a line corresponding to a movement of the input apparatus 500. Accordingly, if a user wishes to input a text or a drawing, the user may change the direction of the input apparatus 500 such that the side including the cross-shaped touch pattern touches the touch panel and perform a touch interaction.

Meanwhile, if the side of the input apparatus 500 which comes in contact with the touch panel of the display apparatus 100 changes, the display apparatus 100 may determine that the user controlling the input apparatus 500 has changed.

For example, if a touch interaction to cause the side including a square-shaped touch pattern of the input apparatus 500 to touch the touch panel is input, the display apparatus 100 may determine that the touch interaction is input by ‘user A’.

If the side of the input apparatus 500, which comes in contact with the touch panel is changed by the user while a touch interaction is input, the display apparatus 100 may determine that the touch interaction is input by ‘user B’.

Meanwhile, whether to determine that changing of the form of a touch pattern means changing of a user may change depending on settings. In other words, a user may set in the setting menu of the display apparatus 100 whether to use changing of the form of a touch pattern as a mode to change a user using the display apparatus.

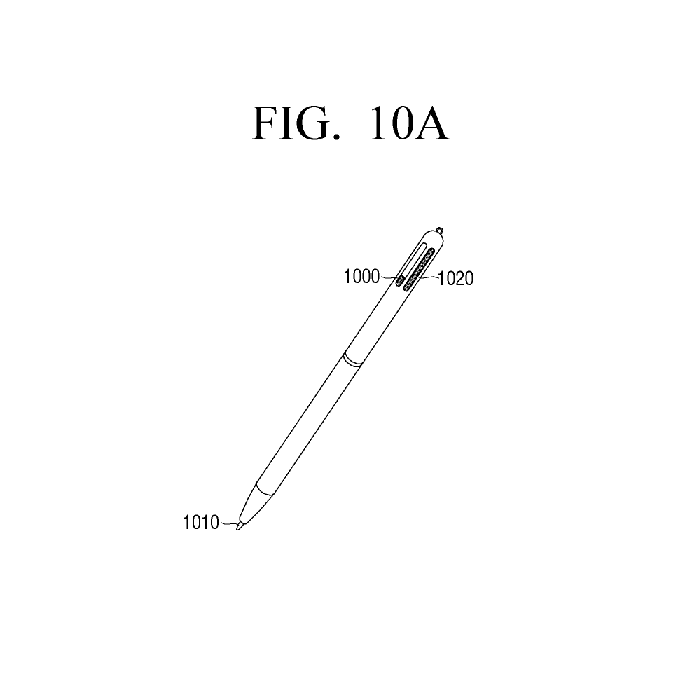

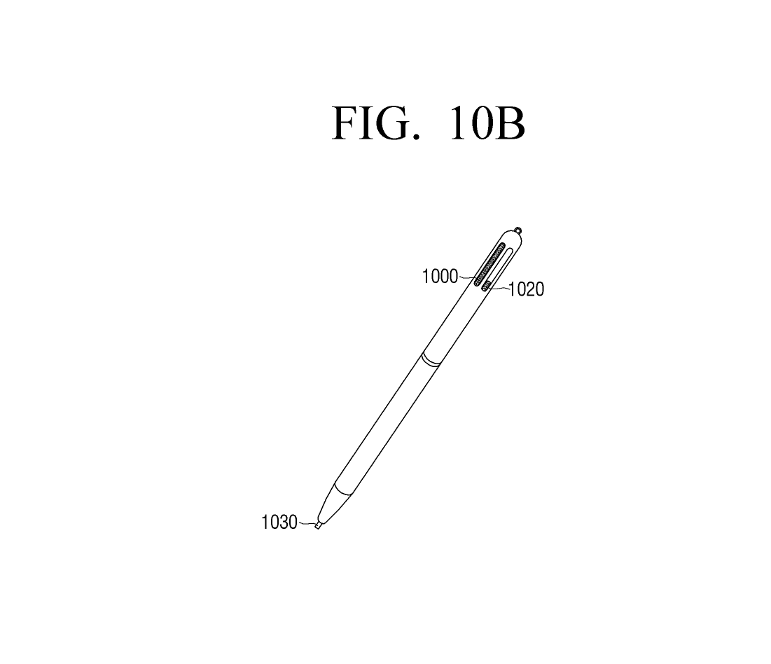

In addition, an input apparatus including a plurality of touch patterns may be configured in the forms illustrated in FIGS. 10A and 10B. Specifically, an input apparatus may be realized as a pen having a plurality of colors. Accordingly, by a user's manipulation of selecting a selection unit for selecting the form of different touch patterns of the input apparatus, the form of the touch patterns of the input apparatus becomes different.

Specifically, as illustrated in FIG. 10A, if there is a user manipulation of selecting a first selection unit 1000, a touch pattern 1010 in a round form is protruded. As illustrated in FIG. 10B, if there is a user manipulation of selecting a second selection unit 1020, a touch pattern 1030 in a triangle form is protruded. Accordingly, a user may change the form of touch patterns by a simple manipulation.

In the above description, an input apparatus is configured in a hexahedron form or in the form of a pen, but this is only an example. The input apparatus may include a touch pattern, and may be realized in various forms as long as a user can use it with a display of a display apparatus.

Meanwhile, in the case where ‘user A’ and ‘user B’ executes a game application through the display apparatus 100, the display apparatus 100 may collect and store a game record by each user.

In addition, in the case where a user executes a search application through the display apparatus 100, the display apparatus 100 may analyze and store a search record for each user. Accordingly, the display apparatus 100 may provide the stored search record for each user.

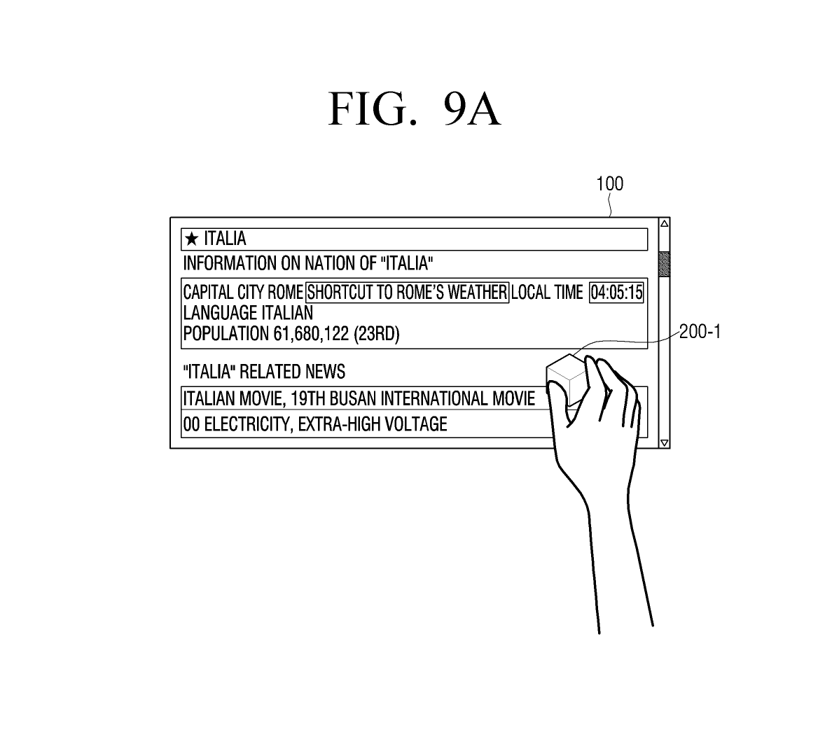

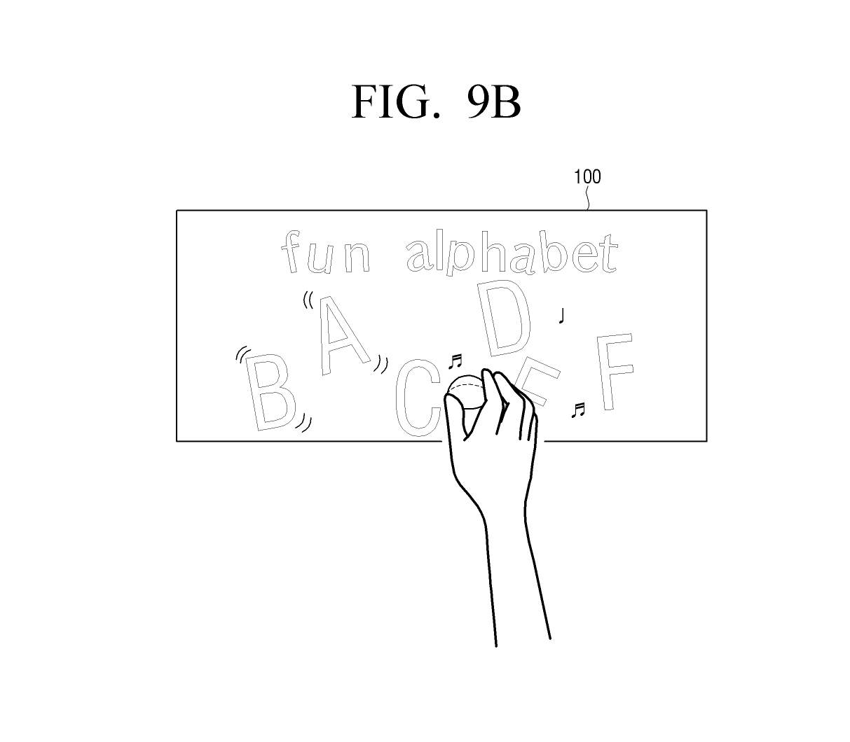

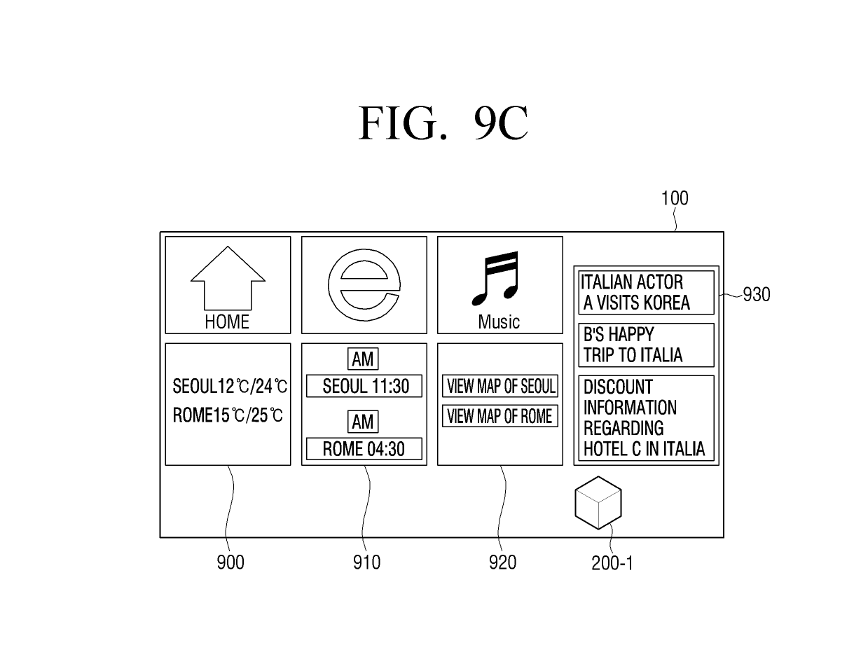

Specifically, an exemplary embodiment of storing a record of each user using the display apparatus 100 will be described with reference to FIGS. 9A to 9C.

As illustrated in FIG. 9A, a user who uses the input apparatus 200-1 including a touch pattern in an arbitrary form may perform a search regarding ‘Italia’ through a search application. In this case, the display apparatus 100 may match the form of a touch pattern included in the input apparatus 200-1 with the search record regarding ‘Italia’ and store the information.

As illustrated in FIG. 9B, a user who uses the input apparatus 200-2 including a touch pattern in a different form may execute a game application. In this case, the display apparatus 100 may match the form of a touch pattern included in the input apparatus 200-2 with the information regarding the executed game application and store the information.

Subsequently, as illustrated in FIG. 9C, if a touch pattern which is the same as the touch pattern of the input apparatus 200-1 which is used when performing a search regarding ‘Italia’ is detected, the display apparatus 100 may provide information regarding ‘Italia’. In other words, the display apparatus 100 may display not only the basic information and application provided in the initial screen but also the information regarding ‘Italia’.

The method for the display apparatus 100 to detect different touch patterns as described above may be realized in various ways, such as the method of using a plurality of input apparatuses including different touch patterns as illustrated in FIGS. 9A to 9C, the method of controlling to change the form of touch patterns through a plurality of input units included in the single input apparatus 400 as illustrated in FIGS. 4A to 4C, the method of changing the side of the input apparatus 500 including different touch patterns, which comes in contact with a touch panel as illustrated in FIGS. 5A and 5B, and the method of selecting a plurality of touch patterns by a user manipulation as illustrated in FIGS. 10A and 10B.

In addition, an input apparatus including a plurality of touch patterns may be realized in various ways. For example, an input apparatus configured in the form of a hexahedron may include a touch pattern in the form of a die on each side.

Accordingly, when a game application using a die is executed through the display apparatus 100, an input apparatus including a touch pattern in the form of a dice may be used.

Specifically, if the side of an input apparatus, which includes two dots as a touch pattern, is located on top by the user manipulation of through the input apparatus on the display apparatus 100, the display apparatus 100 may recognize the number ‘2’ just like a user recognizes the number ‘2’. In other words, if a touch pattern consisting of two dots is on the top of the input apparatus, it means that the side which comes in contact with the display apparatus includes a touch pattern consisting of five dots. Accordingly, when the display apparatus 100 recognizes a touch pattern including five dots, the number ‘2’ can be recognized.

In this case, the input apparatus including a touch pattern in the form of a die may include a touch pattern where the shape of the dots is realized in various ways. In other words, when ‘user A’ and ‘user B’ execute a game application which uses a die through the display apparatus 100, if a number is detected by an input apparatus which includes a touch pattern in the shape of a die with round-shaped dots, the display apparatus 1100 may recognize it as a result of ‘user A’. Alternatively, if a number is detected by an input apparatus which includes a touch pattern in the shape of a die with star-shaped dots, the display apparatus 100 may it as a result of ‘user B’.

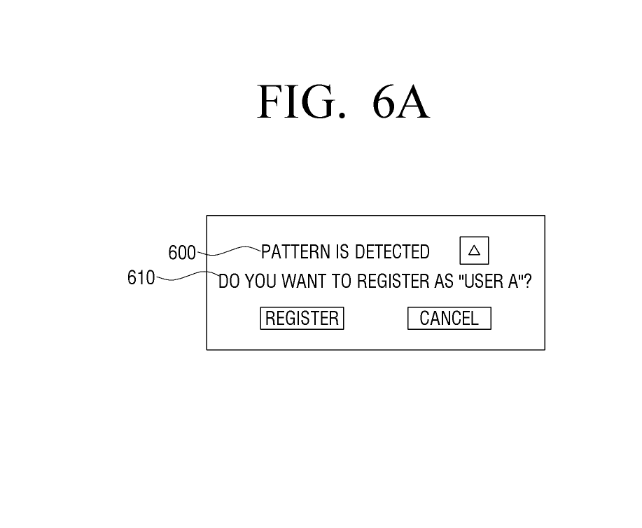

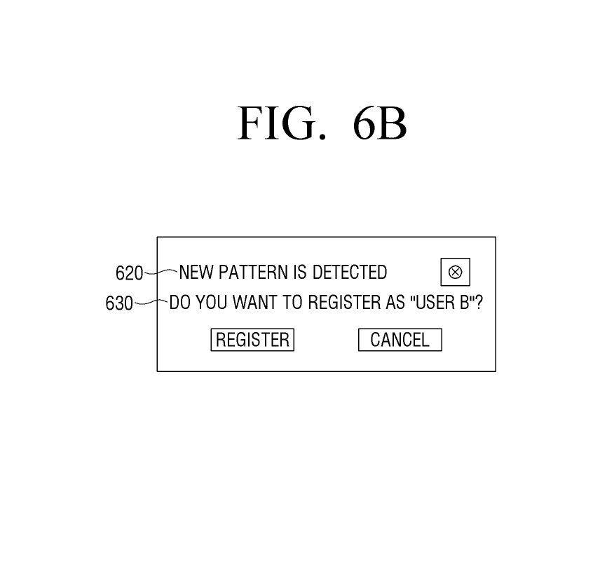

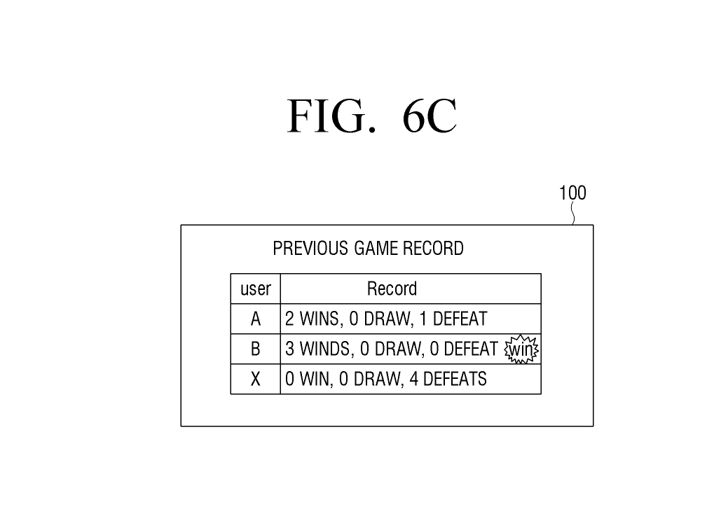

FIGS. 6A to 6C are views illustrating a display apparatus which displays a UI (User Interface).

If an input apparatus including a touch pattern is detected through a touch panel at the same location for more than a predetermined time, the display apparatus 100 may display a UI for registering a user who uses the input apparatus. Alternatively, if a user command to register a user is input with respect to the display apparatus 100, the display apparatus 100 may display a UI for registering a user.

For example, as illustrated in FIG. 6A, if a touch pattern in a certain form is detected through a touch panel for more than a predetermined time, the display apparatus 100 may display the form of the detected touch pattern along with a message 600 of ‘a pattern is detected’.

In addition, if a different touch pattern is detected on a separate setting menu by a user setting, the function for recognizing the corresponding user as a different user may be turned on. In this case, the display apparatus 100 may recognize the detection of a different touch pattern as a different user automatically, or may display a UI as illustrated in FIG. 6A.

Subsequently, the display apparatus 100 may display a message 610 of ‘Do you want to be registered as user A?’. Accordingly, if an input apparatus including a touch pattern is located on ‘registration UI’ displayed on a touch panel for more than a predetermined time or a tap interaction is input with respect to ‘registration UI’, the display apparatus 100 may match the detected form with ‘user A’ and register the information.

Thus, the display apparatus 100 may analyze and store movements of the input apparatus of ‘user A’ after user registration, selection of display items, results of various searches performed through the display apparatus 100, etc.

Meanwhile, when an input apparatus regarding ‘user A’ is stored and a touch interaction regarding a new touch pattern is detected, the display apparatus 100 may display a UI as illustrated in FIG. 6B.

Specifically, the display apparatus 100 may display the form of the detected touch along with a message 620 of ‘new pattern is detected’. The display apparatus 10 may display a message 610 of “Do you want to be registered as user X?’.

Meanwhile, a user name may be in the order of alphabets or numbers according to the order of detection. Alternatively, a user may personally register his or her own name.

The display apparatus 100 may register a user according to the form of each pattern, and analyze and store a touch interaction result of each user. For example, after a game application is executed by ‘user A’, ‘user B’, and ‘user X’ using input apparatuses including different forms, the display apparatus 100 may analyze and store a game result of each user without a separate user command. In addition, the display apparatus 100 may display a stored game result as a table as illustrated in FIG. 6C.

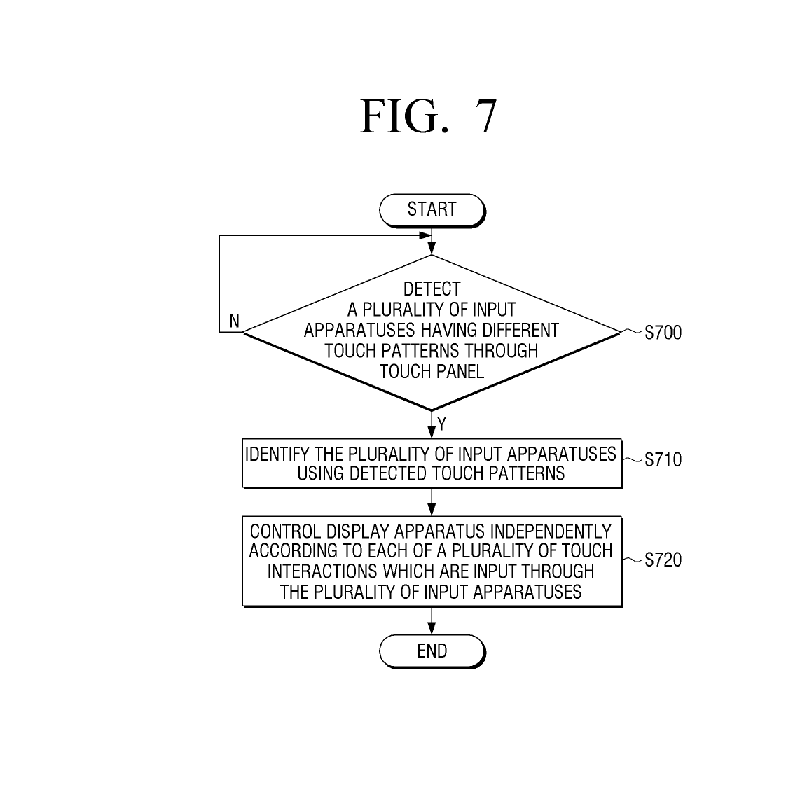

FIG. 7 is a flowchart illustrating a controlling method of the display apparatus 100 according to an exemplary embodiment. First of all, the display apparatus 100 determines whether a plurality of input apparatuses having different touch patterns are detected through a touch panel (S700).

Specifically, if the display apparatus 100 includes a capacitive touch panel and a touch interaction is detected by an input apparatus including a touch pattern which is realized as a conductor, the form of the touch pattern may be identified.

In other words, if a touch interaction where an input apparatus touches a capacitive touch panel of the display apparatus 100 is performed, the capacitance C of the touch pattern which is realized as a conductor of the input apparatus is changed. Accordingly, the display apparatus 100 may detect the touch interaction of the input apparatus by detecting the change of the capacitance C.

The display apparatus 100 identifies a plurality of input apparatuses using a detected touch pattern (S710). In other words, if a different touch pattern is detected, the display apparatus 100 may determined that a touch interaction is input by a different input apparatus.

The display apparatus 100 controls the display apparatus independently according to each of a plurality of touch interactions which are input through a plurality of input apparatuses (S720). For example, the display apparatus 100 may determine that each input apparatus including different touch patterns is controlled by a different user. Accordingly, the display apparatus 100 may receive a touch interaction of each user individually.

Alternatively, the display apparatus 100 may control different functions by each input apparatus including different touch patterns. For example, if touch interactions are input by two different input apparatuses including different types of touch patterns, the display apparatus 100 may determine that the input apparatuses are an apparatus for drawing with respect to a touch panel and an apparatus for deleting a text, drawing, etc. displayed on the touch panel, respectively.

The controlling method of a display apparatus according to the above-described various exemplary embodiments may be coded as software and stored in a non-transitory computer readable medium which can be mounted and used in various apparatuses.

The non-transitory recordable medium refers to a medium which may store data semi-permanently rather than storing data for a short time, such as register, cache, memory, etc. and is readable by an apparatus. Specifically, the above-described various applications and programs may be stored and provided in a non-transitory recordable medium such as CD, DVD, hard disk, Blu-ray disk, USB, memory card, ROM, etc.

The foregoing embodiments and advantages are merely exemplary and are not to be construed as limiting the present embodiments. The present teaching can be readily applied to other types of apparatuses. Also, the description of the exemplary embodiments of the present embodiments is intended to be illustrative, and not to limit the scope of the claims, and many alternatives, modifications, and variations will be apparent to those skilled in the art.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. A display apparatus, comprising:
a display configured to include a touch panel; and
a controller configured to, in response to detecting, through the touch panel, a plurality of input apparatuses having different touch patterns, identify the plurality of input apparatuses using detected touch patterns, and control the display apparatus independently according to each of a plurality of touch interactions which are input through the plurality of input apparatuses.

2. The apparatus as claimed in claim 1, wherein the controller, in response to detecting, through the touch panel, an input apparatus having a first pattern through the touch panel, determines the input apparatus as a first input apparatus, and in response to detecting another input apparatus having a second pattern, determines the another input apparatus as a second input apparatus.

3. The apparatus as claimed in claim 2, wherein the controller controls the display apparatus to perform a first function according to a first touch interaction which is input through the first input apparatus, and controls the display apparatus to perform a second function according to a second touch interaction which is input through the second input apparatus.

4. The apparatus as claimed in claim 2, wherein the controller, in response to the first pattern being changed to the second pattern while recognizing the first pattern from the input apparatus having the first pattern from among the plurality of input apparatuses, determines that a user command, to control a display item on the touch panel where the input apparatus is located, is input.

5. The apparatus as claimed in claim 2, wherein the controller, in response to the first pattern being changed to the second pattern while recognizing the first pattern from the input apparatus having the first pattern from among the plurality of input apparatuses, determines that a user controlling the input apparatus is changed.

6. The apparatus as claimed in claim 1, wherein the controller, in response to detecting, through the touch panel, the input apparatus having one of the touch patterns at a same location for one of more than a predetermined time and a setting manipulation to recognize a change of a user controlling the input apparatus being input, controls the display to display a UI (user interface) to register the user who uses the input apparatus.

7. The apparatus as claimed in claim 6, further comprising:
a storage,
wherein the controller controls the storage to match and store a registered user according to the one of the touch patterns.

8. A controlling method of a display apparatus, comprising:
detecting, through a touch panel, a plurality of input apparatuses having different touch patterns;
identifying the plurality of input apparatuses using detected touch patterns; and
controlling the display apparatus independently according to each of a plurality of touch interactions which are input through the plurality of input apparatuses.

9. The method as claimed in claim 8, wherein the identifying comprises, in response to detecting, through the touch panel, an input apparatus having a first pattern, determining the input apparatus as a first input apparatus, and in response to detecting another input apparatus having a second pattern, determining the another input apparatus as a second input apparatus.

10. The method as claimed in claim 9, wherein the controlling comprises controlling the display apparatus to perform a first function according to a first touch interaction which is input through the first input apparatus, and controlling the display apparatus to perform a second function according to a second touch interaction which is input through the second input apparatus.

11. The method as claimed in claim 9, further comprising:
in response to the first pattern being changed to the second pattern while recognizing the first pattern from the input apparatus having the first pattern from among the plurality of input apparatuses, determining that a user command, to control a display item on the touch panel where the input apparatus is located, is input.

12. A display system, comprising:
an input apparatus including a touch pattern; and
a display apparatus configured to, in response to detecting the input apparatus having the touch pattern through a touch panel, identify the input apparatus using a detected touch pattern, and receive a touch interaction through the input apparatus.

13. The system as claimed in claim 12, wherein the display apparatus, in response to detecting, through the touch panel, the input apparatus having a first pattern, determines the input apparatus as a first input apparatus, and in response to detecting another input apparatus having a second pattern, determines the another input apparatus as a second input apparatus.

14. The display system as claimed in claim 12, wherein the input apparatus includes a plurality of touch patterns, and in response to a user command to control a display item displayed on the display apparatus indicated by the input apparatus being input, changes an activated touch pattern.

15. A method, comprising:
identifying one of plural input devices according to an interaction pattern of the device; and
controlling a display independently responsive to different identified input devices.

16. The method as claimed in claim 15, wherein the interaction pattern has a shape corresponding to the device.

17. The method as claimed in claim 16, wherein a user is correlated to the shape corresponding to device.

18. The method as claimed in claim 16, wherein the shape is a graphic structure of an electronic mark markable by the device.

19. The method as claimed in claim 15, wherein the interaction pattern corresponds to an interaction function of the device.

20. The method as claimed in claim 15, wherein the interaction pattern corresponds to a user of the device.
